(19) United States
(12) Patent Application Publication
(10) Pub. No.: US 2015/0046995 A1
(43) Pub. Date: Feb. 12, 2015

(54) MEDIA PLAYING SYSTEM AND MEDIA PLAYING METHOD FOR PLAYING MEDIA FILE IN DIFFERENT AREA NETWORK GROUPS

(71) Applicant: Primax Electronics Ltd., Taipei (TW)

(72) Inventor: JUNG-CHANG YANG, Taipei (TW)

(73) Assignee: Primax Electronics Ltd., Taipei (TW)

(21) Appl. No.: 14/079,229

(22) Filed: Nov. 13, 2013

(30) Foreign Application Priority Data
Aug. 9, 2013 (TW) 102128692

(51) Int. Cl. H04L 29/06

(52) U.S. Cl. CPC H04L 63/083
USPC 726/7; 709/219

(57) ABSTRACT

A media playing method is provided for playing a media file in different area network groups. Firstly, a first area network group is connected to a network group server through network connection. Then, a communication address data of the second area network group and a device data of an electronic device of the second area network group are acquired from the network group server. According to the communication address data and the device data, a control command is transmitted from the first area network group to the electronic device. According to the control command, the electronic device performs a corresponding controlled task. By using the media playing method, it is not necessary to frequently communicate plural electronic devices with each other. Consequently, the data transmission speed is largely enhanced.

### FIELD OF THE INVENTION

The present invention relates to a media playing method, and more particularly to a media playing method for playing a media file in different area network groups.

### BACKGROUND OF THE INVENTION

Generally, an area network group comprises a local area network (LAN), a metropolitan area network (MAN) and a wide area network (WAN). With increasing development of science and technology, the area network group further comprises a universal plug and play (UPnP) group and a Digital Living Network Alliance (DLNA). For example, the Digital Living Network Alliance (DLNA) is an alliance organization that is composed by the manufacturers of consumer electronics products, mobile phones and computers. The DLNA is responsible for defining unified transmission specifications to allow a variety of products from different manufacturers to be connected and communicated with each other. Consequently, a first electronic device and a second electronic device that comply with the DLNA protocol can be in direct communication with each other in order to transfer data or make synchronization actions.

First of all, some DLNA architectures will be illustrated as followed. FIG. 1 schematically illustrates a first conventional DLNA architecture. As shown in FIG. 1, the first conventional DLNA architecture 1 comprises a network router 10, a digital media server (DMS) 11, and a digital media player (DMP) 12. The network router 10 is connected to an internet (not shown). In addition, the network router 10 is in communication with the digital media server 11 and the digital media player 12. Consequently, the communication between the digital media server 11 and the digital media player 12 is established through the network router 10. A media file 15 is stored in the digital media server 11. The media file 15 is for example an audio file, an image file or a video file. After the digital media player 12 is in communication with the digital media server 11, the digital media player 12 may search the media file 15 from the digital media server 11. After the media file 15 is selected by the user through the digital media player 12, the media file 15 is transmitted from the digital media server 11 to a temporary memory 121 of the digital media player 12. After the media file 15 is received by the digital media player 12, the media file 15 that is temporarily stored in the temporary memory 121 can be played by the digital media player 12.

FIG. 2 schematically illustrates a second conventional DLNA architecture. As shown in FIG. 2, the second conventional DLNA architecture 2 comprises a network router 20, a digital media server (DMS) 21, and a digital media renderer (DMR) 23. The communication between the digital media server 21 and the digital media renderer 23 is established through the network router 20. The digital media server 21 is used for storing a media file 25. In addition, the digital media server 21 further provides a control function of controlling operations of the digital media renderer 23. The digital media renderer 23 is used for receiving and playing the media file 25 that is transmitted from the digital media server 21. After the control function of the digital media server 21 is utilized to select the stored media file 25 from the digital media server 21, the media file 25 is transmitted from the digital media server 21 to the digital media renderer 23. Consequently, the media file 25 can be played by the digital media renderer 23.

FIG. 3 schematically illustrates a third conventional DLNA architecture. As shown in FIG. 3, the third conventional DLNA architecture 2 comprises a network router 30, a digital media server (DMS) 31, a digital media renderer (DMR) 33, and a digital media controller (DMC) 34. The communication between the digital media server 31, the digital media renderer 33 and the digital media controller 34 is established through the network router 30. The digital media server 31 is used for storing a media file 35. The digital media renderer 33 is used for receiving and playing the media file 35 that is transmitted from the digital media server 31. The digital media controller 34 provides a control function. After the control function of the digital media controller 34 is utilized to select the stored media file 35 from the digital media server 31, the media file 35 is transmitted from the digital media server 31 to the digital media renderer 33. Consequently, the media file 35 can be played by the digital media renderer 33.

As mentioned above, the digital media server, the digital media controller, the digital media renderer and the digital media player that are included in the same network domain and comply with the DLNA protocol may transfer or play media files through the network router. For example, a user in a living room may allow a mobile phone to be connected to a computer host in a study room. Moreover, through the mobile phone, the user may browse the audio files in the computer and select a desired audio file from the computer the computer. Then, the selected audio file is transmitted from the mobile phone to a stereo device in the living room. After the audio file is received by the stereo set, the audio file is played by the stereo device. Consequently, the purposes of conveniently and quickly sharing media contents can be achieved.

However, the above media sharing method is only applied to the same DLNA-based media sharing system, but fails to be applied to another DLNA-based media sharing system. For solving this drawback, a content distribution system is disclosed in for example Chinese Patent Publication No. CN102244654. The content distribution system is used for establishing the communication between a first local area network and a second local area network. A method of establishing the communication between the first local area network and the second local area network by the conventional content distribution system will be illustrated as follows. The user of the first local area network has to manually input a second internet protocol address of the second local area network into a transmission mechanism of a transmission gateway device, and the user has to manually input associated information of the passive electronic devices (e.g. a digital media server and a digital media renderer) of the second local area network into the transmission mechanism. Similarly, the user of the second local area network has to manually input a first internet protocol address of the first local area network into the reception mechanism of the reception gateway device, and the user has to input associated information of the passive electronic devices into the reception mechanism. Consequently, the first local area network may operate these passive electronic devices of the second local area network according to the second internet protocol address and the information of the passive electronic devices. The operations of the second local area network are similar, and are not redundantly described herein.

However, the way of manually inputting the internet protocol address and the information of the passive electronic devices of another local area network results in two problems. Firstly, during operations of the conventional content distribution system, the transmission mechanism and the reception mechanism should highly communicate with each other. Secondly, if one of the passive electronic devices of the second local area network is disabled, the first local area network is unable to realize whether the passive electronic device is disabled. That is, the user of the first local area network fails to realize the operating states of the passive electronic devices of the second local area network. Consequently, the user of the first local area network fails to realize which passive electronic devices are available.

The first problem will be illustrated in more details as follows. When the user of the first local area network wants to listen to an audio file of the second local area network, the user may utilize a controller of the first local area network to output a control command. After the control command is transmitted to the transmission gateway device, the transmission mechanism of the transmission gateway device may recognize the control command and judge whether the control command is outputted or not. In particular, the transmission mechanism may inquire of the controller whether the control command is outputted and inquire of the second local area network whether any content reception device is present or not. After the inquiring tasks are completed and the confirmation response signals from the controller and the second local area network are received by the transmission mechanism, the transmission mechanism judges that the control command can be outputted. Meanwhile, the transmission mechanism designates the transmission gateway device to transmit the control command. Consequently, the transmission gateway device will transmit the control command to the reception gateway device of the second local area network according to the second internet protocol address.

Similarly, the reception mechanism of the reception gateway device may recognize the control command and judge whether the control command is outputted or not. In particular, the reception mechanism may inquire of the controller whether the control command is outputted and inquire of the second local area network whether any content reception device is in the second local area network or not. After the inquiring tasks are completed and the confirmation response signals from the controller and the content reception device are received by the reception mechanism, the reception mechanism judges that the control command can be transmitted. Meanwhile, the control command is transmitted from the reception gateway device to a content reproduction device of the second local area network. Consequently, via the controller, the user can browse the audio file in the content reproduction device of the second local area network and play the audio file.

From the above discussions about the conventional content distribution system, the transmission mechanism is the only component of the first local area network that has the second internet protocol address, and the reception mechanism is the only component of the second local area network that has the first internet protocol address. That is, the control command or the media file needs to be sent by the transmission mechanism and the reception mechanism. Moreover, the transmission mechanism and the reception mechanism should frequently communicate with each other or frequently communicate with other devices. In other words, the conventional media sharing method of the content distribution system is time-consuming and has reduced data transmission speed. In addition, the conventional media sharing method wastes the systematic resources of the content distribution system.

The above-mentioned second problem will be illustrated in more details as follows. After the content reproduction device of the second local area network is disabled, the user of the first local area network fails to immediately realize whether the content reproduction device has been disabled. When the controller is utilized by the user of the first local area network to output the control command to the content reproduction device, the control command cannot be received by the content reproduction device because the content reproduction device is disabled. During the process of communicating the transmission mechanism with the reception, the content reproduction device fails to transmit the confirmation response signal because the content reproduction device is disabled. Since the confirmation response signal is not received by the reception mechanism, the transmission mechanism judges that the control command fails to be transmitted. Under this circumstance, the user of the first local area network can just realize that the content reproduction device has got trouble.

Therefore, there is a need of providing a media playing method for playing a media file in different area network groups in order to enhance the data transmission speed and immediately report the operating statuses of the area network groups.

### SUMMARY OF THE INVENTION

The present invention provides a media playing method for playing a media file in different area network groups in order to enhance the data transmission speed.

The present invention provides a media playing method for playing a media file in different area network groups in order to immediately report the operating statuses of the area network groups.

In accordance with an aspect of the present invention, there is provided a media playing method for playing a media file in different area network groups so as to allow at least one electronic device of a second area network group to be controlled by a first area network group. The media playing method includes the following steps. Firstly, the first area network group is allowed to login into a network group server, and the second area network group is allowed to login into the network group server. Then, the first area network group acquires a communication address data corresponding to the second area network group and a device data corresponding to the electronic device from the network group server. Then, the communication address data of the second area network group and the device data of the electronic device are stored into the first area network group. Afterwards, a control command is transmitted from the first area network group to the electronic device of the second area network group according to the communication address data of the second area network group, so that the electronic device performs a controlled task corresponding to the control command.

In accordance with another aspect of the present invention, there is provided a media playing method for playing a media file in different area network groups so as to allow at least one electronic device of a second area network group to be controlled by a first area network group. The media playing method includes the following steps. Firstly, the first area network group is allowed to login into a network group server according to a first account and a first password, and the second area network group is allowed to login into the network group server according to a second account and a second password. Then, the network group server judges whether the first account and the second account are identical and the first password and the second password are identical. If the network group server judges that the first account and the second account are identical and the first password and the second password are identical, a communication address data corresponding to the second area network group and a device data corresponding to the electronic device is acquired from the network group server by the first area network group. Then, the communication address data of the second area network group and the device data of the electronic device are stored into the first area network group. Afterwards, a control command is transmitted from the first area network group to the electronic device of the second area network group according to the communication address data of the second area network group, so that the electronic device performs a controlled task corresponding to the control command.

In accordance with a further aspect of the present invention, there is provided a media playing system for playing a media file. The media playing system includes a network group server, a first area network group, and a second area network group. The first area network group is connected to the network group server through network connection. The first area network group includes a first network router, a first digital media controller, and a first connection module. The first network router is connected to the network group server through network connection to provide a network connection function. The first digital media controller is connected to the first network router through network connection for transmitting a control command. The first connection module is connected to the first network router through network connection so as to login into the network group server. The second area network group is connected to the network group server through network connection. The second area network group includes a second network router, a second digital media server, and a second connection module. The second network router is connected to the network group server through network connection to provide the network connection function. The second digital media server is connected to the second network router through network connection for storing the media file. When the control command is received by the second digital media server, the second digital media server executes the control command. The second connection module is connected to the second network router through network connection so as to login into the network group server. A second communication address data corresponding to the second area network group and a second device data are transmitted from the network group server to the first connection module. In addition, a first communication address data corresponding to the first area network group and a first device data are transmitted from the network group server to the second connection module.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates a first conventional DLNA architecture;

FIG. 2 schematically illustrates a second conventional DLNA architecture;

FIG. 3 schematically illustrates a third conventional DLNA architecture;

FIG. 4 is a schematic functional block diagram illustrating a media playing system according to a first embodiment of the present invention;

FIGS. 5A and 5B schematically illustrate a flowchart illustrating a media playing method for playing a media file in different area network groups according to a first embodiment of the present invention;

FIGS. 6A and 6B schematically illustrate a flowchart illustrating a procedure of allowing the first area network group to login into the network group server in the media playing method according to the first embodiment of the present invention;

FIG. 7 is a flowchart illustrating a procedure of acquiring the second communication address data and the second device data from the network group server in the media playing method according to the first embodiment of the present invention;

FIGS. 8 and 9 schematically illustrate a first device list shown on the first display screen of the first digital media controller of the media playing system according to the first embodiment of the present invention;

FIG. 10 is a schematic functional block diagram illustrating a media playing system according to a second embodiment of the present invention;

FIGS. 11A and 11B schematically illustrate a flowchart of a media playing method for playing a media file in different area network groups according to a second embodiment of the present invention; and

FIG. 12 is a flowchart illustrating a procedure of allowing the first area network group to login into the network group server in the media playing method according to the second embodiment of the present invention.

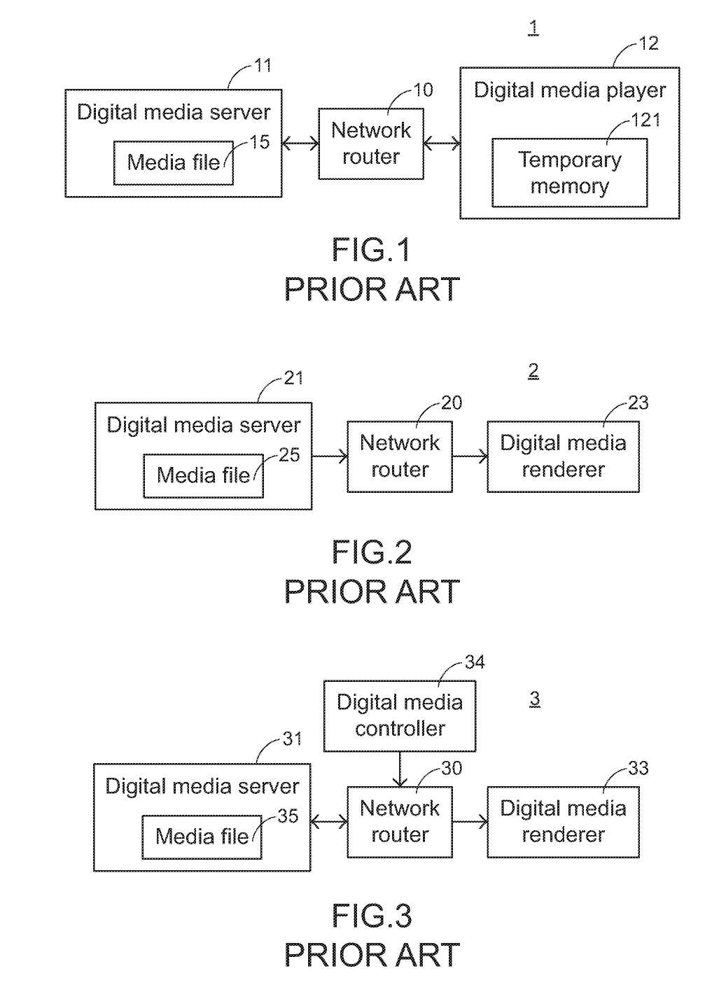

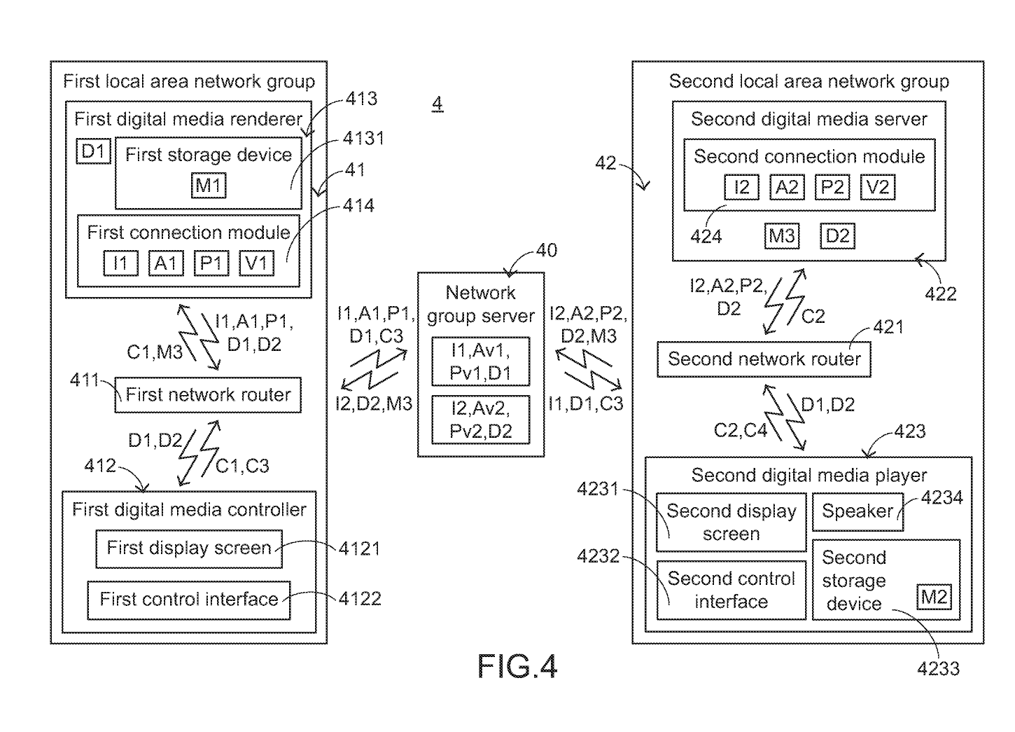

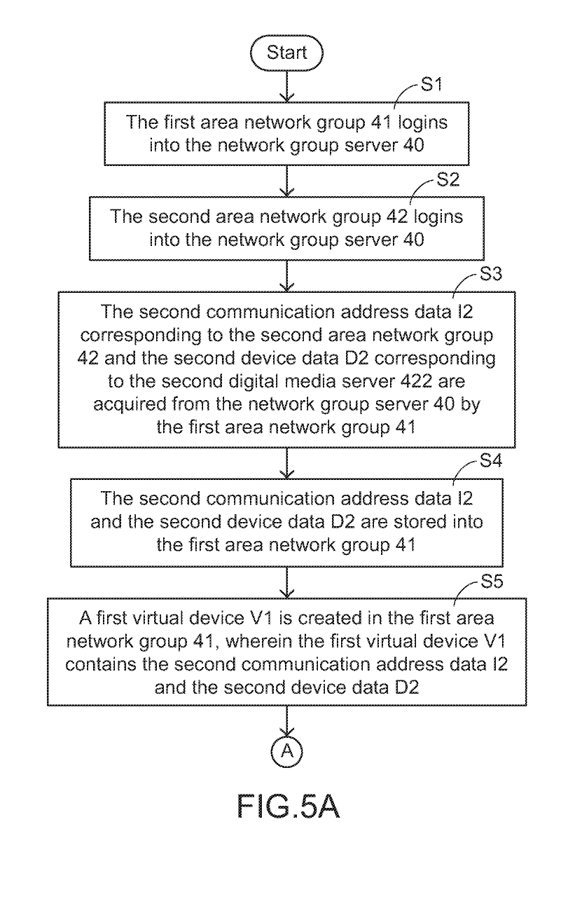

### DETAILED DESCRIPTION OF THE PREFERRED EMBODIMENT

For eliminating the drawbacks of the conventional technology, the present invention provides a media playing method for playing a media file in different area network groups.

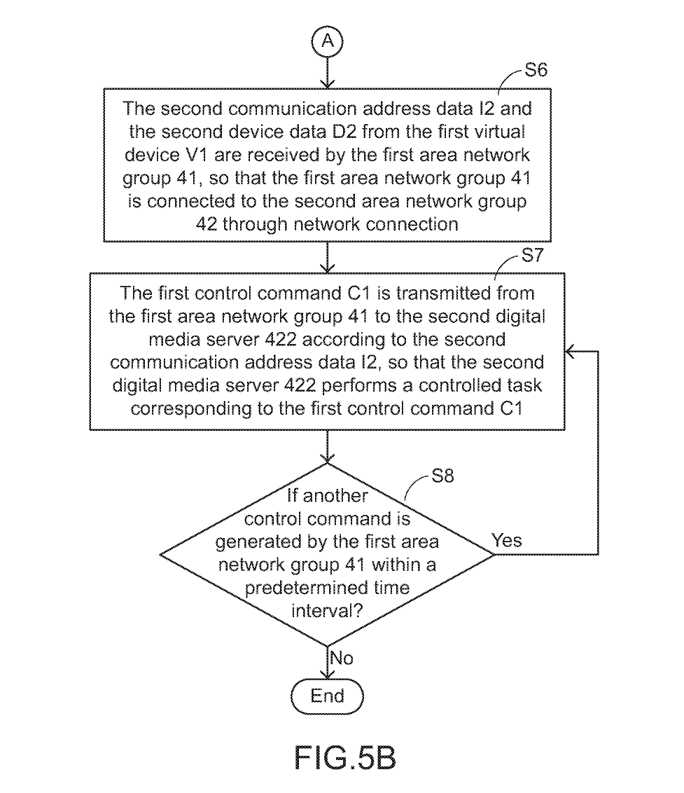

FIG. 4 is a schematic functional block diagram illustrating a media playing system according to a first embodiment of the present invention. As shown in FIG. 4, the media playing system 4 comprises a network group server 40, a first area network group 41, and a second area network group 42. The first area network group 41 and the second area network group 42 are connected to the network group server 40 through network connection. The first area network group 41 comprises a first network router 411, a first digital media controller 412, a first digital media renderer 413, and a first connection module 414. The second area network group 42 comprises a second network router 421, a second digital media server 422, a second digital media player 423, and a second connection module 424. In this embodiment, the first network router 411 and the second network router 421 comply with the universal plug and play (UPnP) protocol. Moreover, all of the first digital media controller 412, the first digital media renderer 413, the second digital media server 422 and the second digital media player 423 comply with the Digital Living Network Alliance (DLNA) protocol.

In the first area network group 41, the first network router 411 is connected to the network group server 40 through network connection so as to provide a network connection function. The first digital media controller 412 is connected to the first network router 411 through network connection. In response to a user's operation, the first digital media controller 412 generates a first control command C1. The first digital media controller 412 comprises a first display screen 4121 and a first control interface 4122. The first control interface 4122 is used for inputting the user's operation in order to allow the first digital media controller 412 to generate the first control command C1. The first digital media renderer 413 is connected to the first network router 411 through network connection. In response to the first control command C1, the first digital media renderer 413 executes a corresponding controlled task. The first digital media renderer 413 comprises a first storage device 4131. The first storage device 4131 is included in the first digital media renderer 413 for storing a first media file M1. An example of the first media file M1 includes but is not limited to a video file or an audio file. After the first control command C1 from the first digital media controller 412 is received by the first digital media renderer 413, the first digital media renderer 413 will play the first media file M1. Moreover, in case that the first control command C1 is an internet radio station playback command, the first digital media renderer 413 may be connected to an internet radio station (not shown) through network connection via the first network router 411 so as to play a streaming media file (not shown) from the internet radio station. For example, the streaming media file is an audio file

The first connection module 414 is connected to the first network router 411 through network connection. Moreover, a first communication address data I1, a first account A1 and a first password P1 corresponding to the first area network group 41 have been previously stored in the first connection module 414. The first connection module 414 may login into the network group server 40 by means of the first account A1 and the first password P1. After the first connection module 414 logins into the network group server 40, the first communication address data I1 is acquired by the network group server 40. In this embodiment, the first connection module 414 is a software component and included in the first digital media renderer 413, but is not limited thereto. Alternatively, in some other embodiments, the first connection module may be included in the first digital media controller.

After the first connection module 414 logins into the network group server 40, the first connection module 414 will inquire of the passive electronic device of the first area network group 41. In particular, a first device data D1 corresponding to the first digital media renderer 413 is transmitted from the first digital media renderer 413 to the first connection module 414, and then the first device data D1 is transmitted from the first connection module 414 to the network group server 40. Meanwhile, the first digital media renderer 413 logins into the network group server 40. Under this circumstance, other users of the first area network group 41 can realize which passive electronic devices are included in the first area network group 41 through the network group server 40.

Generally, the digital media controller and the digital media player complying with the DLNA protocol are referred as active electronic devices. In response to the user's operation, the active electronic device generates a corresponding control command. In addition, the digital media server and the digital media renderer complying with the DLNA protocol are referred as passive electronic devices. In response to the control command from the active electronic device, the passive electronic device performs a corresponding controlled task.

In the second area network group 42, the second network router 421 is connected to the network group server 40 through network connection so as to provide a network connection function. The second digital media player 423 is connected to the second network router 421 through network connection. In response to a user's operation, the second digital media player 423 generates a second control command C2. The second digital media player 423 comprises a second display screen 4231, a second control interface 4232, a second storage device 4233, and a speaker 4234. The second storage device 4233 is used for storing a second media file M2. For example, the second media file M2 is a video file. After the second control command C2 is received, the speaker 4234 plays the audio content of the second media file M2. The second control interface 4232 is used for inputting the user's operation in order to allow the second digital media player 423 to generate the second control command C2. The second display screen 4231 is used for displaying the media file that is stored in the second storage device 4233. Alternatively, in response to the second control command C2, the image content of the second media file M2 is played by the second display screen 4231.

The second digital media server 422 is connected to the second network router 421 through network connection. The second digital media server 422 is used for storing a third media file M3. Alternatively, in response to the second control command C2, the third media file M3 is transmitted by the second digital media server 422. The second connection module 424 is connected to the second network router 421 through network connection. Moreover, a second communication address data I2, a second account A2 and a second password P2 corresponding to the second area network group 42 have been previously stored in the second connection module 424. The second connection module 424 may login into the network group server 40 by means of the second account A2 and the second password P2. After the second connection module 424 logins into the network group server 40, the second communication address data I2 is acquired by the network group server 40. In this embodiment, the second connection module 424 is a software component and included in the second digital media server 422, but is not limited thereto. Alternatively, in some other embodiments, the second connection module may be included in the second digital media player.

The subsequent actions of the second area network group 42 are similar to those of the first area network group 41. After the second connection module 424 logins into the network group server 40, the second connection module 424 will inquire of the passive electronic device of the second area network group 42. In particular, a second device data D2 corresponding to the second digital media server 422 is transmitted from the second digital media server 422 to the second connection module 424, and then the second device data D2 is transmitted from the second connection module 424 to the network group server 40. Meanwhile, the second digital media server 422 logins into the network group server 40. Under this circumstance, other users of the second area network group 42 can realize which passive electronic devices are included in the second area network group 42 through the network group server 40. In this embodiment, both of the first communication address data I1 and the second communication address data I2 are internet protocol addresses.

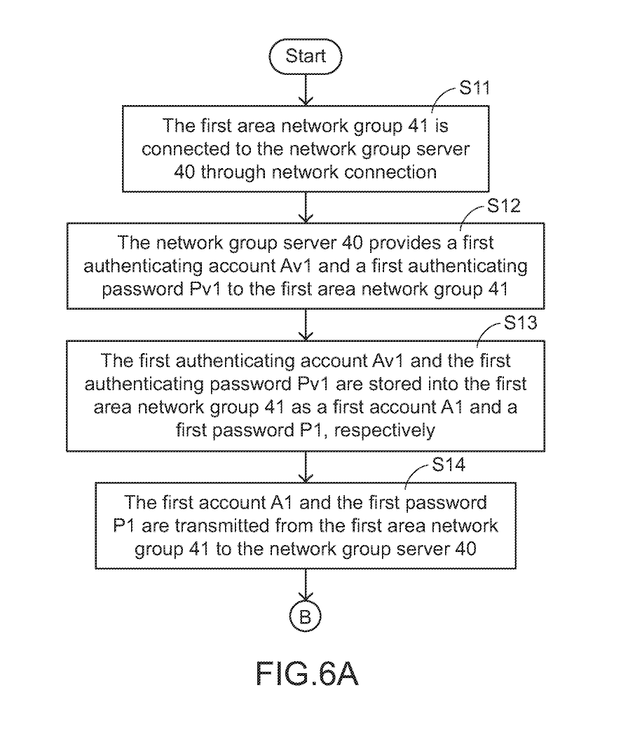

Hereinafter, a media playing method for playing a media file in different area network groups will be illustrated with reference to FIGS. 4 and 5. FIGS. 5A and 5B schematically illustrate a flowchart illustrating a media playing method for playing a media file in different area network groups according to a first embodiment of the present invention.

Firstly, in the step S1, the first area network group 41 logins into the network group server 40. In the step S2, the second area network group 42 logins into the network group server 40. In the step S3, the second communication address data I2 corresponding to the second area network group 42 and the second device data D2 corresponding to the second digital media server 422 are acquired from the network group server 40 by the first area network group 41. In the step S4, the second communication address data I2 and the second device data D2 are stored into the first area network group 41. In the step S5, a first virtual device V1 is created in the first area network group 41, wherein the first virtual device V1 contains the second communication address data I2 and the second device data D2. In the step S6, the second communication address data I2 and the second device data D2 from the first virtual device V1 are received by the first area network group 41, so that the first area network group 41 is connected to the second area network group 42 through network connection. In the step S7, the first control command C1 is transmitted from the first area network group 41 to the second digital media server 422 according to the second communication address data I2, so that the second digital media server 422 performs a controlled task corresponding to the first control command C1. Then, the step S8 is performed to judge whether another control command is generated by the first area network group 41 within a predetermined time interval.

In the step S8, if another control command is generated by the first area network group 41 within the predetermined time interval, the step S7 is performed again. Whereas, if no other control command is generated by the first area network group 41 within the predetermined time interval, the flowchart of the media playing method is ended. After the flowchart of the media playing method is ended, if another control command is generated by the first area network group 41, the step S7 is directly performed. That is, it is not necessary to perform the step S1 again. However, after the first area network group 41 or the second area network group 42 no longer logins into the network group server 40 (i.e. logouts from the network group server 40), if the controlled task corresponding to the first control command C1 has to be performed, the steps S1-S7 should be repeatedly done.

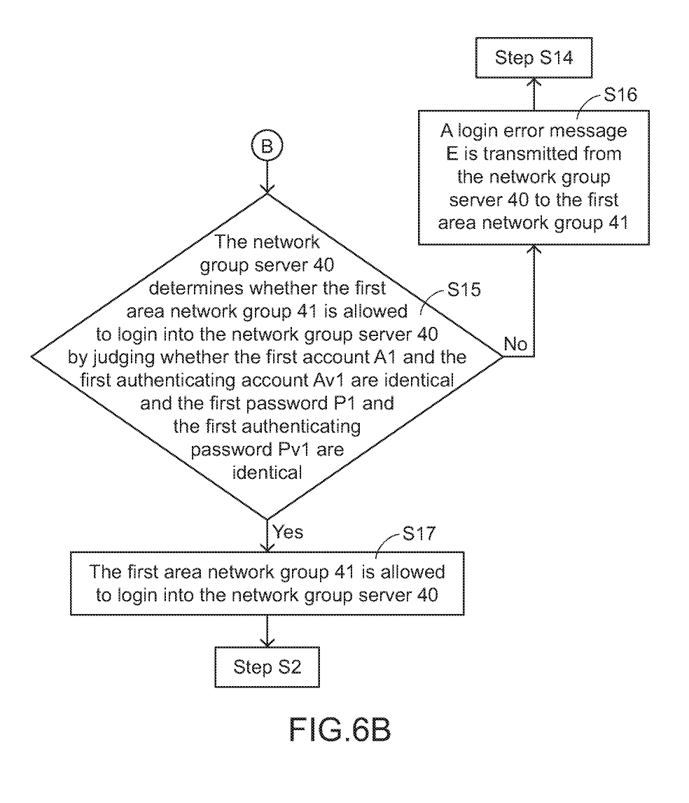

Hereinafter, the detailed procedure of the step S1 will be illustrated with reference to FIGS. 6A and 6B. FIGS. 6A and 6B schematically illustrate a flowchart illustrating a procedure of allowing the first area network group to login into the network group server in the media playing method according to the first embodiment of the present invention.

As shown in FIGS. 6A and 6B, the step S1 comprises the following sub-steps. In the sub-step S11, the first area network group 41 is connected to the network group server 40 through network connection. In the sub-step S12, the network group server 40 provides a first authenticating account Av1 and a first authenticating password Pv1 to the first area network group 41. In the sub-step S13, the first authenticating account Av1 and the first authenticating password Pv1 are stored into the first area network group 41 as a first account A1 and a first password P1, respectively. In the sub-step S14, the first account A1 and the first password P1 are transmitted from the first area network group 41 to the network group server 40. In the sub-step S15, the network group server 40 determines whether the first area network group 41 is allowed to login into the network group server 40 by judging whether the first account A1 and the first authenticating account Av1 are identical and the first password P1 and the first authenticating password Pv1 are identical. If the judging condition of the sub-step S15 is not satisfied, the sub-step S16 is performed to transmit a login error message E from the network group server 40 to the first area network group 41. If the judging condition of the sub-step S15 is satisfied, the sub-step S17 is performed to allow the first area network group 41 to login into the network group server 40.

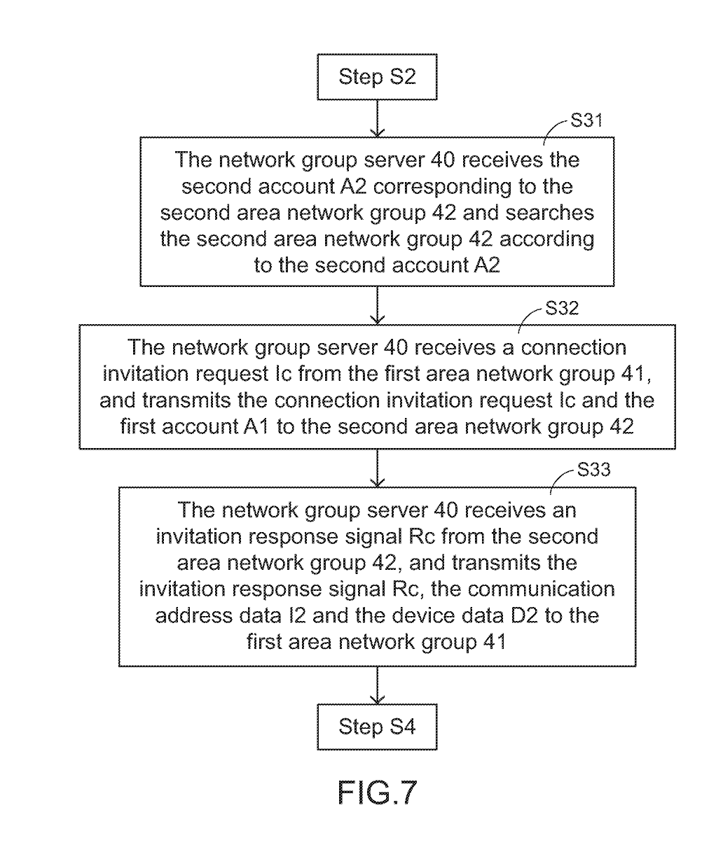

Hereinafter, the detailed procedure of the step S3 will be illustrated with reference to FIG. 7. FIG. 7 is a flowchart illustrating a procedure of acquiring the second communication address data and the second device data from the network group server in the media playing method according to the first embodiment of the present invention.

As shown in FIG. 7, the step S3 comprises the following sub-steps. In the sub-step S31, the network group server 40 receives the second account A2 corresponding to the second area network group 42, and searches the second area network group 42 according to the second account A2. In the sub-step S32, the network group server 40 receives a connection invitation request Ic from the first area network group 41, and transmits the connection invitation request Ic and the first account A1 to the second area network group 42. In the sub-step S33, the network group server 40 receives an invitation response signal Rc from the second area network group 42, and transmits the invitation response signal Rc, the communication address data I2 and the device data D2 to the first area network group 41.

Before the media playing method of the present invention is performed by the media playing system 4 of the present invention, the following preliminary steps are previously performed by the media playing system 4. As shown in FIG. 4, before the media playing method is performed by the media playing system 4, plural electronic devices of the first area network group 41 are connected with each other through network connection only. However, the plural electronic devices of the first area network group 41 are not connected with the network group server 40 and the second area network group 42 through network connection. That is, the first digital media controller 412 and the first digital media renderer 413 including the first connection module 414 are connected with each other through the first network router 411. Consequently, the first digital media controller 412 and the first digital media renderer 413 are added to the first area network group 41 to establish the internal network connection of the first area network group 41. After the internal network connection of the first area network group 41 is established, a first device list L1 is shown on the first display screen 4121 of the first digital media controller 412.

The above preliminary steps are previously performed by the media playing system 4 according to the DLNA protocol. During the process of adding the first digital media controller 412 and the first digital media renderer 413 to the first area network group 41, the actions of the first digital media controller 412 and the first digital media renderer 413 according to the DLNA protocol will be illustrated as follows. When the first digital media controller 412 serving as the active electronic device is added to the first area network group 41, the first digital media controller 412 may actively inquire of the first area network group 41 whether any passive electronic device is present. If a passive electronic device is present, a device data corresponding to the passive electronic device is transmitted from the passive electronic device to the first digital media controller 412, and stored into the first digital media controller 412. Consequently, the first device list L1 shown on the first display screen 4121 of the first digital media controller 412 may additionally contain the device data of the passive electronic device and the media file of the passive electronic device. Under this circumstance, the user may utilize the first digital media controller 412 to operate the passive electronic device.

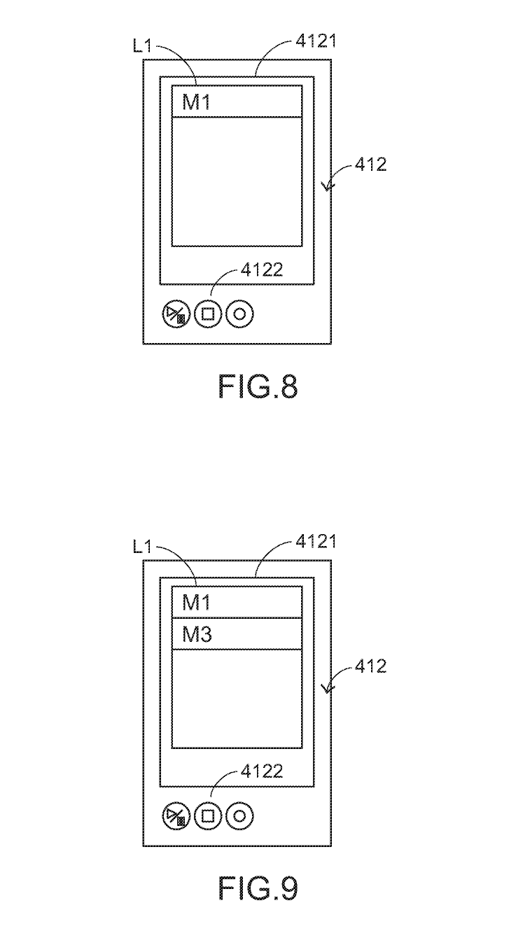

On the other hand, when the first digital media renderer 413 serving as the passive electronic device is added to the first area network group 41, the first digital media renderer 413 may actively notify all active electronic devices of the first area network group 41. In particular, the first device data D1 is transmitted from the first digital media renderer 413 to the first digital media controller 412. Consequently, the first device data D1 is stored into the first digital media controller 412. In addition, the first device list L1 shown on the first display screen 4121 of the first digital media controller 412 may additionally contain the information about the first media file M1 stored in the first digital media renderer 413 (see FIG. 8). The user may utilize the first control interface 4122 to generate the first control command C1. After the first control command C1 is received by the first digital media renderer 413, the first digital media renderer 413 plays the first media file M1 according to the first control command C1.

Hereinafter, the operations of the media playing method performed by the media playing system 4 will be illustrated with reference to FIGS. 4, 5 and 6. First of all, a network server website address data (e.g. http://www.XYZ.com) is built in the first connection module 414. When the user of the first area network group 41 wants to establish the network connection between the first area network group 41 and the network group server 40, the first connection module 414 is connected with the network group server 40 through network connection according to the network server website address data (i.e. the sub-step S11). After the first connection module 414 is connected with the network group server 40 through network connection, the network group server 40 provides the first authenticating account Av1 and the first authenticating password Pv1 to the first connection module 414 (i.e. the sub-step S12). The first authenticating account Av1 and the first authenticating password Pv1 are randomly set by the network group server 40. Then, the first authenticating account Av1 and the first authenticating password Pv1 are stored into the first area network group 41 as the first account A1 and the first password P1, respectively (i.e. the sub-step S13). In a preferred embodiment, a third-party device (e.g. a personal computer, a tablet computer or a smart phone) is used to change the first account A1 and the first password P1 as the desired account and password. After the changed first account A1 and the changed first password P1 are transmitted to the network group server 40, the network group server 40 will store the changed first account A1 and the changed first password P1 as a new first authenticating account Av1 and a new first authenticating password Pv1. Meanwhile, the first account A1 and the first password P1 in the first connection module 414 have been set.

Then, the first account A1 and the first password P1 are transmitted from the first connection module 414 to the network group server 40 (i.e. the sub-step S14), and the network group server 40 judges whether the first account A1 and the first authenticating account Av1 are identical and the first password P1 and the first authenticating password Pv1 are identical (i.e. the sub-step S15). If the network group server 40 judges that the first account A1 and the first authenticating account Av1 are not identical and the first password P1 and the first authenticating password Pv1 are not identical, the login error message E is transmitted from the network group server 40 to the first area network group 41 (i.e. the sub-step S16). Meanwhile, the user of the first area network group 41 may input the first account A1 and the first password P1 again. That is, after the sub-step S16, the sub-step S14 is performed again. Whereas, if the network group server 40 judges that the first account A1 and the first authenticating account Av1 are identical and the first password P1 and the first authenticating password Pv1 are identical, the first area network group 41 is allowed to login into the network group server 40 (i.e. the sub-step S17). The step S2 of allowing the second area network group 42 to login into the network group server 40 is similar to the step S1 of allowing the first area network group 41 to login into the network group server 40, and is not redundantly described herein.

After both of the first area network group 41 and the second area network group 42 login into the network group server 40, the following steps are performed by the media playing system 4. Firstly, the user of the first area network group 41 has to realize the second account A2 of the second area network group 42. For example, the second account A2 of the second area network group 42 is the user name (e.g. David) of the second area network group 42. After the user of the first area network group 41 inquires of the user of the second area network group 42, the second account A2 (i.e. David) of the second area network group 42 is acquired by the user of the first area network group 41. Alternatively, the user of the first area network group 41 may utilize a third-party device to operate a search tool of the network group server 40. By inputting the search keyword (i.e. the second account A2 “David”) into the search tool of the network group server 40, the user of the first area network group 41 can search whether the second account A2 corresponding to the second area network group 42 exists in the network group server 40 (i.e. the sub-step S31). When the second account A2 corresponding to the second area network group 42 is searched by the search tool, the second account A2 is shown on a display screen of the third-party device. After the second account A2 shown on the display screen of the third-party device is selected by the user of the first area network group 41, a connection invitation request Ic is transmitted from the first connection module 414 to the network group server 40. When the second area network group 42 logins into the network group server 40, the connection invitation request Ic, the first communication address data I1 and the first account A1 are transmitted from the network group server 40 to the second area network group 42 (i.e. the sub-step S32).

After the connection invitation request Ic, the first communication address data I1 and the first account A1 are received by the second area network group 42, the user of the second area network group 42 may judge whether the user of the first area network group 41 is a known user according to the first account A1, thereby determining whether the connection invitation request Ic is received or not. When the second area network group 42 decides to accept the connection invitation request Ic, the second connection module 424 transmits the invitation response signal Rc to the network group server 40. Then, the invitation response signal Rc from the second area network group 42 is received by the network group server 40. When the first area network group 41 logins into the network group server 40, the network group server 40 transmits the invitation response signal Rc, the communication address data I2 and the device data D2 to the first connection module 414 (i.e. the sub-step S33).

The reason why the connection invitation request Ic and the invitation response signal Rc are transmitted through the network group server 40 will be illustrated as follows. While the first area network group 41 transmits the connection invitation request Ic, the second area network group 42 may not login into the network group server 40. Similarly, while the second area network group 42 transmits the invitation response signal Rc, the first area network group 41 may not login into the network group server 40. In accordance with the present invention, it is necessary to previously transmit the connection invitation request Ic and the invitation response signal Rc to the network group server 40. Consequently, after the second area network group 42 for receiving the connection invitation request Ic logins into the network group server 40, the connection invitation request Ic is transmitted from the network group server 40 to the second area network group 42. In addition, after the first area network group 41 for receiving the invitation response signal Rc logins into the network group server 40, the invitation response signal Rc is transmitted from the network group server 40 to the first area network group 41.

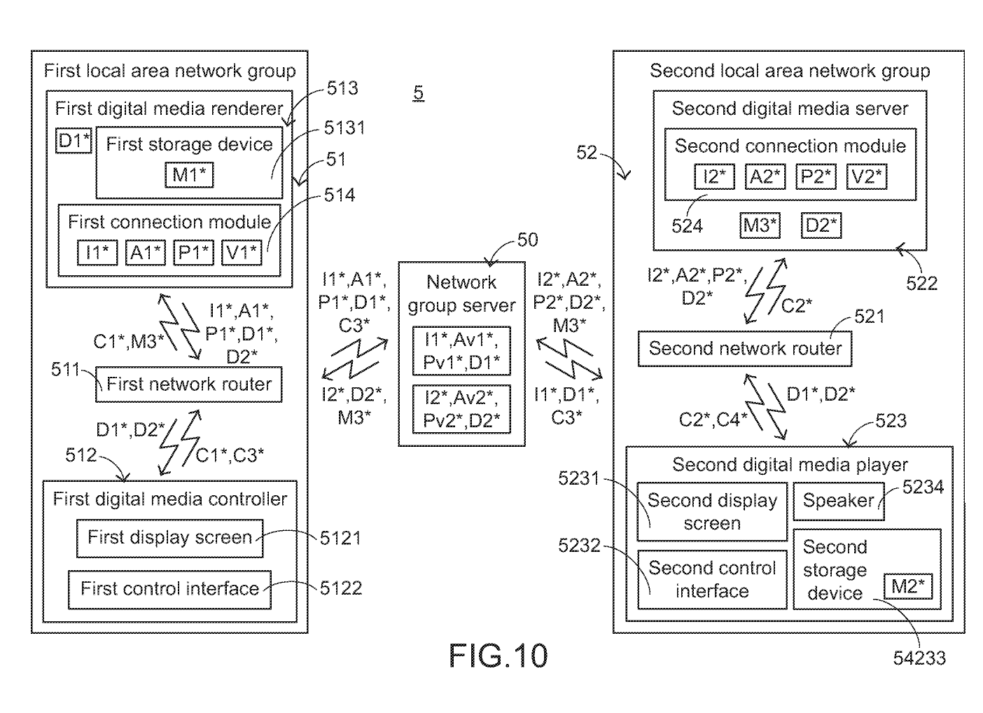

After the invitation response signal Rc, the second communication address data I2 and the second device data D2 are received by the first connection module 414, the second communication address data I2 and the second device data D2 are stored into the first connection module 414 (i.e. the step S4). Then, the first virtual device V1 is created in the first connection module 414, wherein the first virtual device V1 contains the second communication address data I2 and the second device data D2 (i.e. the step S5). Since the first virtual device V1 contains the second communication address data I2 and the second device data D2, the first virtual device V1 is equivalent to the second digital media server 422. That is, the first virtual device V1 belongs to the passive electronic device. In this embodiment, the first virtual device V1 is a virtual digital media server. While the first virtual device V1 established by the first connection module 414 is added to the first area network group 41, the first virtual device V1 serving as the passive electronic device may actively notify all active electronic devices of the first area network group 41. That is, the first virtual device V1 transmits the second device data D2 to the first digital media controller 412. Consequently, the second device data D2 is stored into the first digital media controller 412. In addition, the first device list L1 shown on the first display screen 4121 of the first digital media controller 412 may additionally contain the information about the third media file M1 stored in the second digital media server 422 (see FIG. 9). Meanwhile, the first area network group 41 is connected to the second area network group 42 through network connection (i.e. the step S6).

Then, the user may utilize the first control interface 4122 of the first digital media controller 412 to generate a third control command C3. After the third media file M3 of the first device list L1 is selected, the third control command C3 is transmitted from the first network router 411 to the second digital media server 422 according to the second communication address data I2 and the second device data D2. Consequently, the second digital media server 422 performs a controlled task corresponding to the third control command C3 (i.e. the step S7). In case that the third control command C3 is the command for transmitting a media file to the first virtual device V1, the third media file M3 is transmitted from the second digital media server 422 to the first digital media renderer 413 through the second network router 421 according to the first communication address data I1 and the first device data D1, and the third media file M3 is played by the first digital media renderer 413. In case that the third control command C3 is the command for playing a media file in the second area network group 42, the third media file M3 is transmitted from the second digital media server 422 to the second digital media player 423 through the second network router 421, and the third media file M3 is played by the second digital media player 423.

Afterwards, if another control command is generated by the first area network group 41 within the predetermined time interval (i.e. the step S8), the controlled task corresponding to this control command is performed by the passive electronic device of the second area network group 42. Whereas, if no other control command is generated by the first area network group 41 within the predetermined time interval, the flowchart of the media playing method is ended.

In the above steps S1˜S8, the first area network group 41 is an active control terminal, and the second area network group 42 is a passively controlled terminal. It is noted that the roles of the first area network group 41 and the second area network group 42 of the media playing system 4 are presented herein for purpose of illustration and description only. In some other embodiments, when the user of the second area network group 42 wants to operate the first media file M1 of the first area network group 41, the first area network group 41 is switched from the active control terminal to the passively controlled terminal, and the second area network group 42 is switched from the passively controlled terminal to the active control terminal. At this moment, since the second area network group 42 has been connected with the first area network group 41 through network connection, the media playing system 4 does not need to perform the steps S1˜S4. On the contrary, the media playing system 4 will perform other steps S5′˜S7′.

Hereinafter, the steps S5′˜S7′ will be illustrated in more details. In the step S5′, a second virtual device V2 is created in the second area network group 42, wherein the second virtual device V2 contains the first communication address data I1 of the first area network group 41 and the first device data D1 of the first digital media renderer 413. In the step S6′, the first communication address data I1 and the first device data D1 from the second virtual device V2 are received by the second digital media player 423 of the second area network group 42, so that the second area network group 42 is connected to the first area network group 41 through network connection. In the step S7′, a fourth control command C4 is transmitted from the second digital media server 422 to the first area network group 41 according to the first communication address data I1, so that the first digital media renderer 413 performs a controlled task corresponding to the fourth control command C4.

By performing the steps S5′˜S7′, the user of the second area network group 42 may utilize the second digital media player 423 to operate the first media file M1 of the first digital media renderer 413.

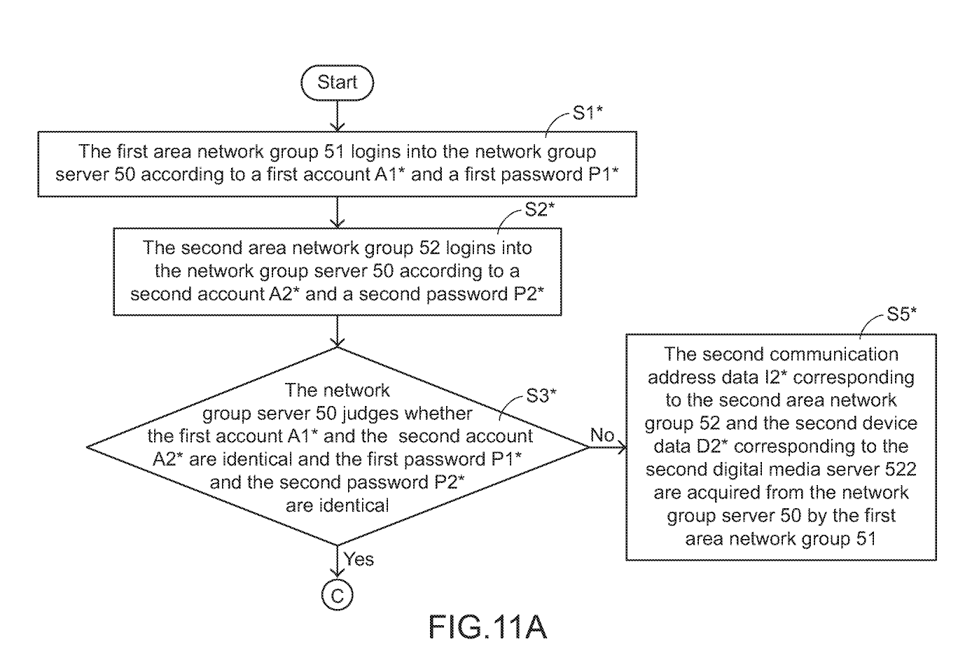

The present further comprises a media playing system of a second embodiment. FIG. 10 is a schematic functional block diagram illustrating a media playing system according to a second embodiment of the present invention. As shown in FIG. 10, the media playing system 5 comprises a network group server 50, a first area network group 51, and a second area network group 52. The first area network group 51 and the second area network group 52 are connected to the network group server 50 through network connection. The first area network group 51 comprises a first network router 511, a first digital media controller 512, a first digital media renderer 513, and a first connection module 514. The second area network group 52 comprises a second network router 521, a second digital media server 522, a second digital media player 523, and a second connection module 524. Except for the following two items, the operations of the media playing system 5 of this embodiment are substantially identical to those of the media playing system 4 of the first embodiment, and are not redundantly described herein.

Firstly, the way of establishing the network connection between the first area network group 51 and the second area network group 52 of the media playing system 5 is distinguished. Secondly, the way of allowing the first area network group 51 to login into the network group server 50 is also distinguished. Hereinafter, a procedure of establishing the network connection between the first area network group 51 and the second area network group 52 (i.e. the first distinguished item) will be illustrated.

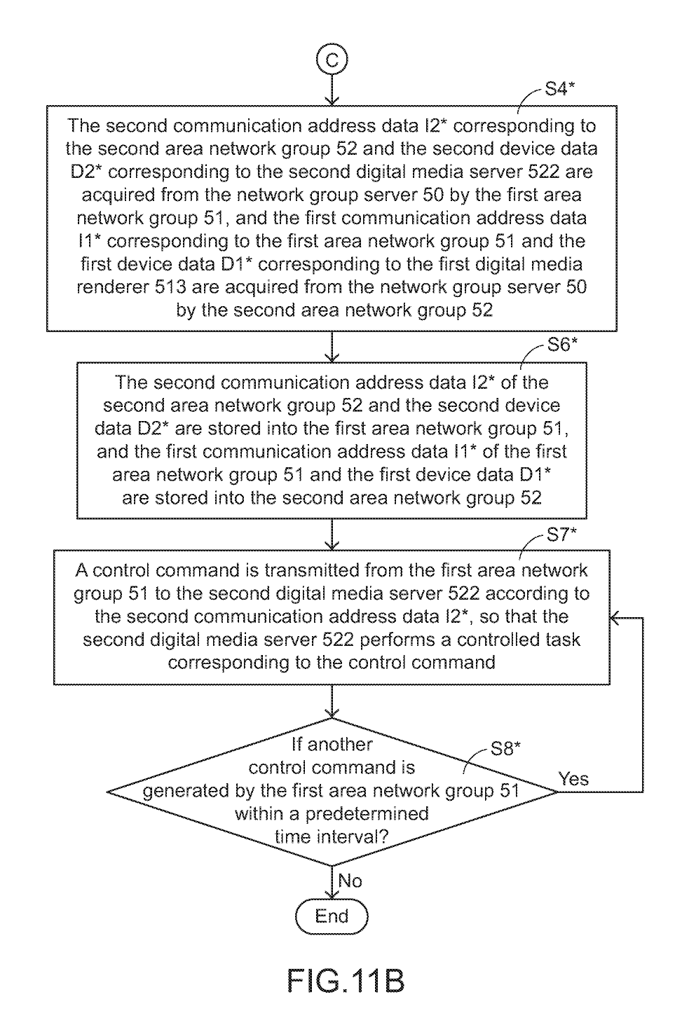

Please refer to FIGS. 10, 11A and 11B. FIGS. 11A and 11B schematically illustrate a flowchart of a media playing method for playing a media file in different area network groups according to a second embodiment of the present invention. Firstly, in the step S1*, the first area network group 51 logins into the network group server 50 according to a first account A1* and a first password P1*. In the step S2*, the second area network group 52 logins into the network group server 50 according to a second account A2* and a second password P2*. In the step S3*, the network group server 50 judges whether the first account A1* and the second account A2* are identical and the first password P1* and the second password P2* are identical. In the step S4*, the second communication address data I2* corresponding to the second area network group 52 and the second device data D2* corresponding to the second digital media server 522 are acquired from the network group server 50 by the first area network group 51, and the first communication address data I1* corresponding to the first area network group 51 and the first device data D1* corresponding to the first digital media renderer 513 are acquired from the network group server 50 by the second area network group 52. In the step S5*, the second communication address data I2* corresponding to the second area network group 52 and the second device data D2* corresponding to the second digital media server 522 are acquired from the network group server 50 by the first area network group 51. In the step S6*, the second communication address data I2* of the second area network group 52 and the second device data D2* are stored into the first area network group 51, and the first communication address data I1* of the first area network group 51 and the first device data D1* are stored into the second area network group 52. In the step S7*, a control command is transmitted from the first area network group 51 to the second digital media server 522 according to the second communication address data I2*, so that the second digital media server 522 performs a controlled task corresponding to the control command. Then, the step S8* is performed to judge whether another control command is generated by the first area network group 51 within a predetermined time interval.

In this media playing method of this embodiment, the user of the first area network group 51 should inform the user of the second area network group 52 about the first account A1* and the first password P1*. Consequently, both of the user of the first area network group 51 and the user of the second area network group 52 can login into the network group server 50 by using the first account A1* and the first password P1*. If the network group server 50 judges that the accounts and the passwords of the first area network group 51 and the second area network group 52 are identical, the first communication address data I1* and the first device data D1* are transmitted from the network group server 50 to the second area network group 52, and the second communication address data I2* and the second device data D2* are transmitted from the network group server 50 to the first area network group 51. Under this circumstance, the first area network group 51 may be connected to the second area network group 52 through network connection in order to control the media playback of the second area network group 52.

In the step S3*, if the network group server 50 judges that the first account A1* and the second account A2* are identical and the first password P1* and the second password P2* are identical, the step S4* is performed. Whereas, if the network group server 50 judges that the first account A1* and the second account A2* are not identical or the first password P1* and the second password P2* are not identical, the step S5* is repeatedly done. The step S5* of this embodiment is equivalent to the step S3 of the first embodiment. That is, if the network group server 50 judges that the first account A1* and the second account A2* are not identical or the first password P1* and the second password P2* are not identical, the media playing method of the first embodiment is sequentially performed. The subsequent procedures posterior to the step S3 have been illustrated in the first embodiment, and are not redundantly described herein.

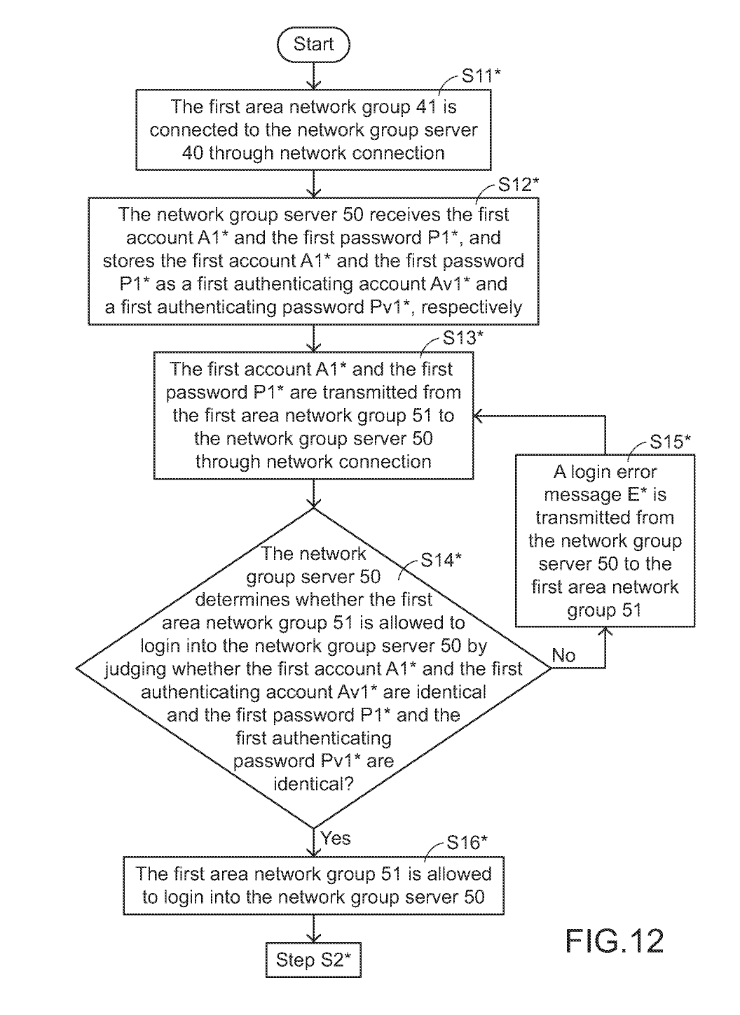

Hereinafter, a procedure of allowing the first area network group 51 to login into the network group server 50 (i.e. the second distinguished item) will be illustrated. FIG. 12 is a flowchart illustrating a procedure of allowing the first area network group to login into the network group server in the media playing method according to the second embodiment of the present invention.

As shown in FIG. 12, the step S1* comprises the following sub-steps. In the sub-step S11*, the first area network group 51 is connected to the network group server 50 through network connection. In the sub-step S12*, the network group server 50 receives the first account A1* and the first password P1*, and stores the first account A1* and the first password P1* as a first authenticating account Av1* and a first authenticating password Pv1*, respectively. In the sub-step S13*, the first account A1* and the first password P1* are transmitted from the first area network group 51 to the network group server 50 through network connection. In the sub-step S14*, the network group server 50 determines whether the first area network group 51 is allowed to login into the network group server 50 by judging whether the first account A1* and the first authenticating account Av1* are identical and the first password P1* and the first authenticating password Pv1* are identical. In the sub-step S15*, a login error message E* is transmitted from the network group server 50 to the first area network group 51. In the sub-step S16*, the first area network group 51 is allowed to login into the network group server 50.

In the step S14*, if the network group server 50 judges that the first account A1* and the first authenticating account Av1* are identical and the first password P1* and the first authenticating password Pv1* are identical, the step S16* is performed. Whereas, if the network group server 50 judges that the first account A1* and the first authenticating account Av1* are not identical or the first password P1* and the first authenticating password Pv1* are not identical, the step S15* is performed. According to the login error message E*, the user may perform the sub-step S13* again.

In a preferred embodiment, a third-party device (e.g. a personal computer, a tablet computer or a smart phone) is used to transmit the first account A1* and the first password P1* to the network group server 50. Consequently, the first authenticating account Av1* and the first authenticating password Pv1* are acquired from the first area network group 51 by the network group server 50. It is noted that the use of the third-party device is presented herein for purpose of illustration and description only. According to the practical requirements, the use of the third-party device as described in the first embodiment is also feasible.

From the above descriptions, the present invention provides a media playing method for playing a media file in different area network groups. Firstly, a first area network group is connected to a network group server through network connection. Then, a communication address data of the second area network group and a device data of an electronic device of the second area network group are acquired from the network group server. The task of connecting the area network group to the network group server through network connection and the task of acquiring the communication address data and the device data are both implemented by a connecting module of the area network group. After the communication address data and the device data are acquired from the network group server, the communication address data and the device data are obtained by all active electronic devices of the area network group. Consequently, the active electronic device of one area network group can directly control the passive electronic device of another area network group. Since it is not necessary to frequently communicate different area network groups with each other, the data transmission speed is largely enhanced.

In the media playing system of the present invention, all passive electronic devices of each area network group should login into the network group server. Moreover, when a specified passive electronic device is added to or removed from the area network group, the added status or the removed status of the specified passive electronic device will be reported to the area network group. Under this circumstance, since the network group server can immediately realize whether each passive electronic device is present or not, the drawbacks of the conventional technology will be eliminated. Moreover, when the user wants to add a new passive electronic device, it is not necessary to manually input associated information of the passive electronic device. In addition, when the user wants to remove an old passive electronic device, it is not necessary to manually input associated information of the passive electronic device. Consequently, the burden on the user is largely reduced.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A media playing method for playing a media file in different area network groups so as to allow at least one electronic device of a second area network group to be controlled by a first area network group, the media playing method comprising steps of:
allowing the first area network group to login into a network group server, and allowing the second area network group to login into the network group server;
allowing the first area network group to acquire a communication address data corresponding to the second area network group and a device data corresponding to the electronic device from the network group server;
storing the communication address data of the second area network group and the device data of the electronic device into the first area network group; and
transmitting a control command from the first area network group to the electronic device of the second area network group according to the communication address data of the second area network group, so that the electronic device performs a controlled task corresponding to the control command.

2. The media playing method according to claim 1, wherein the step of allowing the first area network group to login into the network group server comprises sub-steps of:
connecting the first area network group to the network group server through network connection;
the network group server providing a first authenticating account and a first authenticating password to the first area network group;
storing the first authenticating account and the first authenticating password into the first area network group as a first account and a first password, respectively;
transmitting the first account and the first password from the first area network group to the network group server; and
the network group server determining whether the first area network group is allowed to login into the network group server by judging whether the first account and the first authenticating account are identical and the first password and the first authenticating password are identical, wherein if the network group server judges that the first account and the first authenticating account are identical and the first password and the first authenticating password are identical, the first area network group is allowed to login into the network group server.

3. The media playing method according to claim 1, wherein the step of allowing the first area network group to login into the network group server comprises sub-steps of:
connecting the first area network group to the network group server through network connection;
the network group server receiving the first account and the first password from the first area network group, and storing the first account and the first password as a first authenticating account and a first authenticating password, respectively;
transmitting the first account and the first password from the first area network group to the network group server through network connection; and
the network group server determining whether the first area network group is allowed to login into the network group server by judging whether the first account and the first authenticating account are identical and the first password and the first authenticating password are identical, if the network group server judges that the first account and the first authenticating account are identical and the first password and the first authenticating password are identical, the first area network group is allowed to login into the network group server.

4. The media playing method according to claim 1, wherein the step of allowing the first area network group to acquire the communication address data corresponding to the second area network group and the device data corresponding to the electronic device comprises sub-steps of:
the network group server receiving a second account corresponding to the second area network group, and searching the second area network group according to the second account;
the network group server receiving a connection invitation request from the first area network group, and transmitting the connection invitation request to the second area network group; and
the network group server receiving an invitation response signal from the second area network group, and transmitting the invitation response signal, the communication address data and the device data to the first area network group.

5. The media playing method according to claim 4, wherein after the step of storing the communication address data of the second area network group and the device data of the electronic device into the first area network group, the media playing method further comprises steps of:
creating a virtual device in the first area network group, wherein the first virtual device is equivalent to the electronic device of the second area network group, and the virtual device contains the communication address data and the device data; and
the first area network group receiving the communication address data and the second device data from the virtual device, so that the first area network group is connected to the second area network group through network connection, wherein the first area network group and the second area network group comply with a Digital Living Network Alliance (DLNA) protocol.

6. A media playing method for playing a media file in different area network groups so as to allow at least one electronic device of a second area network group to be controlled by a first area network group, the media playing method comprising steps of:
allowing the first area network group to login into a network group server according to a first account and a first password, and allowing the second area network group to login into the network group server according to a second account and a second password;
the network group server judging whether the first account and the second account are identical and the first password and the second password are identical;
if the network group server judges that the first account and the second account are identical and the first password and the second password are identical, allowing the first area network group to acquire a communication address data corresponding to the second area network group and a device data corresponding to the electronic device from the network group server;
storing the communication address data of the second area network group and the device data of the electronic device into the first area network group; and
transmitting a control command from the first area network group to the electronic device of the second area network group according to the communication address data of the second area network group, so that the electronic device performs a controlled task corresponding to the control command.

7. The media playing method according to claim 6, wherein the step of allowing the first area network group to login into the network group server comprises sub-steps of:
connecting the first area network group to the network group server through network connection;
the network group server providing a first authenticating account and a first authenticating password to the first area network group;
storing the first authenticating account and the first authenticating password into the first area network group as the first account and the first password, respectively;
transmitting the first account and the first password from the first area network group to the network group server; and
the network group server determining whether the first area network group is allowed to login into the network group server by judging whether the first account and the first authenticating account are identical and the first password and the first authenticating password are identical, wherein if the network group server judges that the first account and the first authenticating account are identical and the first password and the first authenticating password are identical, the first area network group is allowed to login into the network group server.

8. The media playing method according to claim 6, wherein the step of allowing the first area network group to login into the network group server comprises sub-steps of:
connecting the first area network group to the network group server through network connection;
the network group server receiving the first account and the first password from the first area network group, and storing the first account and the first password as the first authenticating account and the first authenticating password, respectively;
transmitting the first account and the first password from the first area network group to the network group server through network connection; and
the network group server determining whether the first area network group is allowed to login into the network group server by judging whether the first account and the first authenticating account are identical and the first password and the first authenticating password are identical, if the network group server judges that the first account and the first authenticating account are identical and the first password and the first authenticating password are identical, the first area network group is allowed to login into the network group server.

9. The media playing method according to claim 6, wherein after the step of storing the communication address data of the second area network group and the device data of the electronic device into the first area network group, the media playing method further comprises steps of:
creating a virtual device in the first area network group, wherein the virtual device is equivalent to the electronic device of the second area network group, and the virtual device contains the communication address data and the device data; and
the first area network group receiving the communication address data and the second device data from the virtual device, so that the first area network group is connected to the second area network group through network connection, wherein the first area network group and the second area network group comply with a Digital Living Network Alliance (DLNA) protocol.

10. A media playing system for playing a media file, the media playing system comprising:
a network group server;
a first area network group connected to the network group server through network connection, wherein the first area network group comprises:
a first network router connected to the network group server through network connection to provide a network connection function;
a first digital media controller connected to the first network router through network connection for transmitting a control command; and
a first connection module connected to the first network router through network connection so as to login into the network group server; and
a second area network group connected to the network group server through network connection, wherein the second area network group comprises:
a second network router connected to the network group server through network connection to provide the network connection function;
a second digital media server connected to the second network router through network connection for storing the media file, wherein when the control command is received by the second digital media server, the second digital media server executes the control command; and
a second connection module connected to the second network router through network connection so as to login into the network group server,
wherein a second communication address data corresponding to the second area network group and a second device data are transmitted from the network group server to the first connection module, and a first communication address data corresponding to the first area network group and a first device data are transmitted from the network group server to the second connection module.

11. The media playing system according to claim 10, wherein a first account and a first password corresponding to the first area network group have been previously stored in the first connection module, whether when the first account and the first password are transmitted from the first connection module to the network group server, the network group server judges whether the first account and the first password are authenticated, thereby determining whether the first connection module is allowed to login into the network group server or not, wherein a second account and a second password corresponding to the second area network group have been previously stored in the second connection module, whether when the second account and the second password are transmitted from the second connection module to the network group server, the network group server judges whether the second account and the second password are authenticated, thereby determining whether the second connection module is allowed to login into the network group server or not.

12. The media playing system according to claim 11, wherein a first authenticating account and a first authenticating password corresponding to the first area network group and a second authenticating account and a second authenticating password corresponding to the second area network group have been previously stored in the network group server, wherein if the network group server judges that the first account and the first authenticating account are identical and the first password and the first authenticating password are identical, the first area network group is allowed to login into the network group server, wherein if the network group server judges that the second account and the second authenticating account are identical and the second password and the second authenticating password are identical, the second area network group is allowed to login into the network group server.

13. The media playing system according to claim 11, wherein a first authenticating account and a first authenticating password have been previously stored in the network group server, wherein if the network group server judges that the first account and the first authenticating account are identical and the first password and the first authenticating password are identical, the first area network group is allowed to login into the network group server, wherein after the first area network group logins into the network group server, if the network group server judges that the second account and the second authenticating account are identical and the second password and the second authenticating password are identical, the second area network group is allowed to login into the network group server, the second communication address data of the second area network group and the second device data are transmitted from the network group server to the first connection module, and the first communication address data of the first area network group and the first device data are transmitted from the network group server to the second connection module.

14. The media playing system according to claim 10, wherein after the second communication address data and the second device data of the second digital media server are received by the first connection module, a virtual device corresponding to the second digital media server is created in the first connection module, wherein the virtual device contains the second communication address data and the second device data, wherein according to the second communication address data and the second device data provided by the virtual device, the control command is transmitted from the first digital media controller to the second digital media server.

15. The media playing system according to claim 10, wherein the first area network group further comprises a first digital media renderer, and the first digital media renderer is connected to the first network router through network connection, wherein the first connection module is included in the first digital media controller or the first digital media renderer, wherein the second area network group further comprises a second digital media renderer, and the second digital media renderer is connected to the second network router for playing the media file, wherein the second connection module is included in the second digital media server or the second digital media renderer.

16. The media playing system according to claim 15, wherein after the first connection module logins into the network group server, the first device data corresponding to the first digital media renderer is received by the first connection module, and the first device data is transmitted from the first connection module to the network group server, so that the first digital media renderer logins into the network group server, wherein after the second connection module logins into the network group server, the second device data corresponding to the second digital media server is received by the second connection module, and the second device data is transmitted from the second connection module to the network group server, so that the second digital media server logins into the network group server.

17. The media playing system according to claim 15, wherein after the control command is received by the second digital media server, the media file is transmitted from the second digital media server to the second digital media renderer so as to be played by the second digital media renderer, or the media file is transmitted from the second digital media server to the first digital media renderer so as to be played by the first digital media renderer.

18. The media playing system according to claim 15, wherein the first digital media controller comprises:
a display screen for showing a device list, wherein the device list contains the first device data corresponding to the first digital media renderer or the second device data corresponding to the second digital media server; and
a control interface for allowing a user to provide the control command or select the first device data or the second device data from the device list.
